(19) United States
(12) Patent Application Publication
(10) Pub. No.: US 2012/0061442 A1
(43) Pub. Date: Mar. 15, 2012

(54) GAS-COMBUSTION COILED STRIP NAIL DRIVING DEVICE

(76) Inventor: Yi-Min ZHU, Chongqing (CN)

(21) Appl. No.: 13/246,220

(22) Filed: Sep. 27, 2011

(30) Foreign Application Priority Data
Sep. 12, 2010 (CN) 201010579968.6

(51) Int. Cl. B25C 1/14

(52) U.S. Cl. 227/10

(57) ABSTRACT

The present invention discloses a gas-combustion coiled strip nail driving device including a housing and a nose assembly. The housing mounts therein a cylinder head, a movable sleeve, a cylinder block, and a piston assembly arranged inside the cylinder block. The cylinder head, the movable sleeve, and the cylinder block collectively define a combustion chamber. The nose assembly includes a feeding mechanism that includes a secondary cylinder. An exhaust passage is formed in the cylinder head and communicates the combustion chamber. The housing has an outside surface on which a guide tube is mounted in such a way that the guide tube vertically extends along the housing. The guide tube has an S shape terminal end in communication with the exhaust passage, and a curve that is bent in a direction toward the housing. The guide tube has an opposite end in communication with the secondary cylinder.

### FIELD OF THE INVENTION

The present invention relates to a combustion powered nail driving device, and in particular to a gas-combustion coiled strip nail driving device.

### BACKGROUND OF THE INVENTION

Gas-combustion coiled strip nail driving devices are available in the market and are operated in such a way that a high pressure gas generated in a combustion chamber is used to do work in combination with a reciprocal motion of a nail feeding claw driven by a nail feeding spring so as to achieve feeding of nails.

Chinese Patent No. CN100553890C discloses an invention in respect of gas combustion type driving tool, wherein on a feed cylinder included in a feed piston/cylinder device, a spring is provided for normally urging a feed piston in a feed direction. A portion of the feed cylinder opposite to the spring is connected through a gas conduit to a combustion chamber. In an intermediate portion of the gas conduit, a delay piston/cylinder device is provided. One end of a delay cylinder is disposed on the combustion chamber side, while the other end thereof is disposed on the feed cylinder side. When a delay piston is caused to slide from one end of the delay cylinder to the other end thereof by the pressure of the combustion gas, air compressed within the delay cylinder is supplied from the other end of the delay cylinder to the feed cylinder. The gas conduit has an end connected to a movable sleeve and an opposite end connected to the feed cylinder in order to introduce high-pressure gas from the combustion chamber to the feed cylinder to drive movement of the piston inside the cylinder. The piston compresses the gas inside the cylinder and transmits the pressure to a minor cylinder in a nose part thereby driving a minor piston and a feed claw to move for performing an operation of nail feeding. However, the driving tool carries out nail feeding through a delay device, making the overall structure complicated. Further, the movable sleeve connected to the gas conduit is moving part, making it susceptible to increase damaged parts.

U.S. Pat. No. 5,558,264A discloses a combustion-powered, fastener-driving tool, which comprises a fastener driving device and a fastener feeding device. The fastener driving device comprises a cylinder body in which a hole is made for conducting high pressure gas from a combustion chamber to a feeding mechanism cylinder provided on a nosepiece in order to cooperate with a feeding spring to drive a feeding piston and a feeding claw to achieve an operation of fastener feeding. A detailed description in respect of the structure the fastener feeding device was given in the reference, but the driving tool having such a structure does not conduct the high pressure gas from the combustion chamber into the feeding mechanism cylinder of the nosepiece until the piston assembly moves a predetermined distance. This causes problems such as insufficient advancing (withdrawing) distance of the feeding claw, failure of fastener feeding, and unsmooth operation of fastener feeding.

### SUMMARY OF THE INVENTION

An objective of the present invention is to provide a gas-combustion coiled strip nail driving device that employs high pressure gas to drive and feed nails.

The objective of the present invention is achieved through the following technical solution, wherein a gas-combustion coiled strip nail driving device comprises a housing and a nose assembly. The housing mounts therein a cylinder head, a movable sleeve, a cylinder block, and a piston assembly that is arranged inside the cylinder block. The cylinder head, the movable sleeve, and the cylinder block collectively define a combustion chamber. The nose assembly comprises a feeding mechanism and the feeding mechanism comprises a secondary cylinder. An exhaust passage is formed in the cylinder head and communicates the combustion chamber. The housing has an outside surface on which a guide tube is mounted in such a way that the guide tube vertically extends along the housing. The guide tube has a terminal end in communication with the exhaust passage. The terminal end is provided with a curve that is bent in a direction toward the housing. The guide tube has an opposite end that is in communication with the secondary cylinder. The terminal end is of an S shape.

According to the present invention, the delay device as used in the prior art reference is omitted. In order to have the piston assembly receiving a supply of high pressure gas earlier than a feeding device, the solution adopted in the present invention is providing a curved guide tube, whereby the supply of high pressure gas is subjected to a resistance at the curve to prolong the time required for the high pressure to pass. Meanwhile, the curved guide tube also increases the overall length of the guide tube, making the length of the flow path through which the high pressure gas flows increased. This achieves the objective of allowing the piston assembly to receive the supply of high pressure gas earlier than the feeding device.

Further, forming the exhaust passage in the cylinder head also achieves the objective of allowing the piston assembly to receive the supply of high pressure gas earlier than the feeding device, because the high pressure gas generated in a combustion chamber always flows toward the piston assembly first and then is guided through the exhaust passage into the guide tube. This always makes a time delay and the objective is thus achieved.

Further, the exhaust passage is arranged in a vertical direction in the cylinder head. The exhaust passage has an exit where a discharge nozzle in communication with the exhaust passage is formed. The guide tube is set in communication with the exhaust passage through the discharge nozzle.

To facilitate connection of the guide tube to the discharge nozzle, the curve is formed of a curved tube and the guide tube communicates the discharge nozzle through the curved tube.

To prevent leakage occurring in the course of flow of the high pressure gas that leads to pressure reduction of the high pressure gas and also to provide functions of compression and connection, threaded collars are respectively provided at a connection between the discharge nozzle and the exhaust passage, a connection between the discharge nozzle and the curved tube, and a connection between the guide tube and the secondary cylinder.

The guide tube can be a metal tube or a rubber tube. It is apparent that the guide tube can be made of other materials as desired for specific applications.

To discharge the exhaust gas from the secondary cylinder, the secondary cylinder has a wall in which exhaust holes in communication with the secondary cylinder are formed. The exhaust holes are located at a bottom of the wall of the secondary cylinder.

By adopting the above techniques, the present invention shows the advantages of simple structure and being convenient and reliable by using a single guide tube to realize supply of high pressure gas to the feeding device, preventing undesired interference between nail driving operation and nail feeding operation thereby achieving precise nail driving operation and nail feeding operation and also reducing manufacturing costs.

### BRIEF DESCRIPTION OF THE DRAWINGS

The present invention will be apparent to those skilled in the art by reading the following description of preferred embodiments thereof with reference to the drawings, in which:

FIG. 1 is a cross-sectional schematic view illustrating the structure of the present invention;

FIG. 2 is a cross-sectional schematic view illustrating high pressure gas does work on a secondary cylinder; and

FIG. 3 is a schematic view illustrating a nose assembly according to the present invention.

### DETAILED DESCRIPTION OF THE PREFERRED EMBODIMENTS

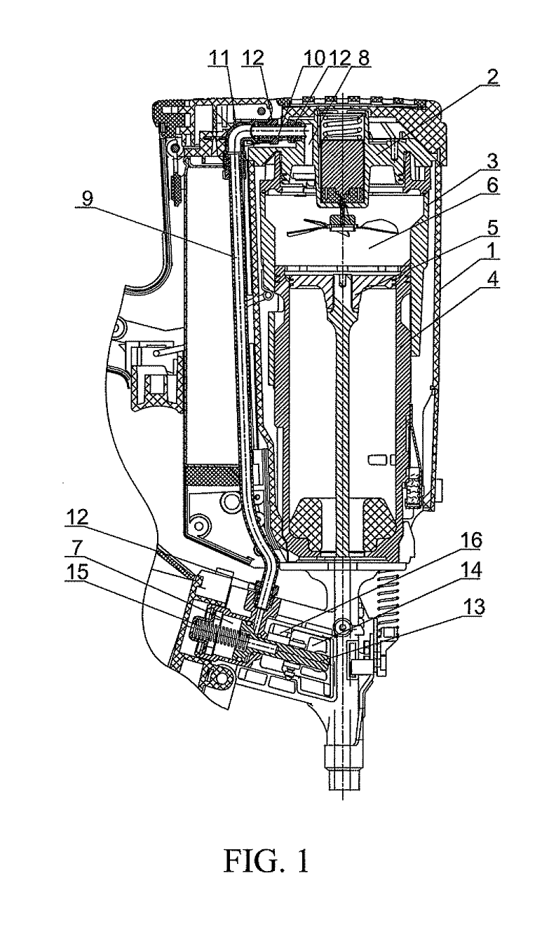

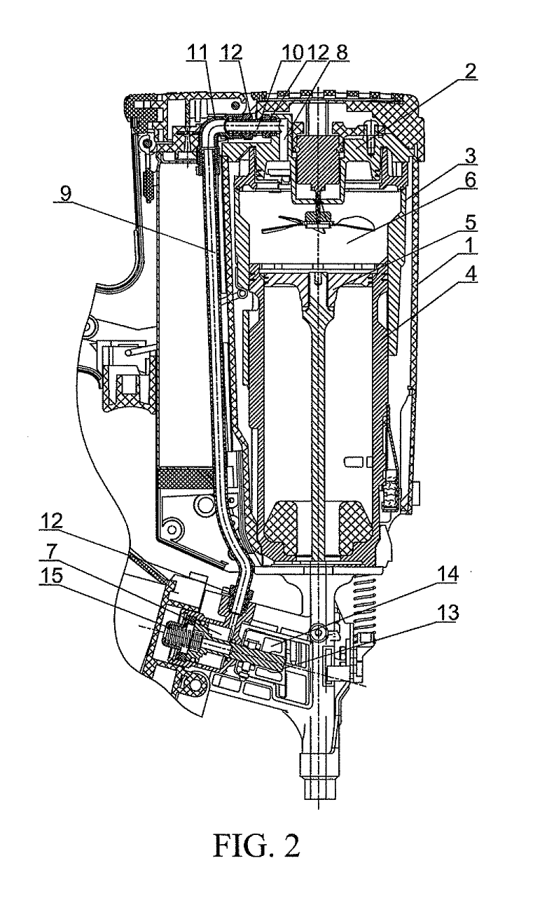

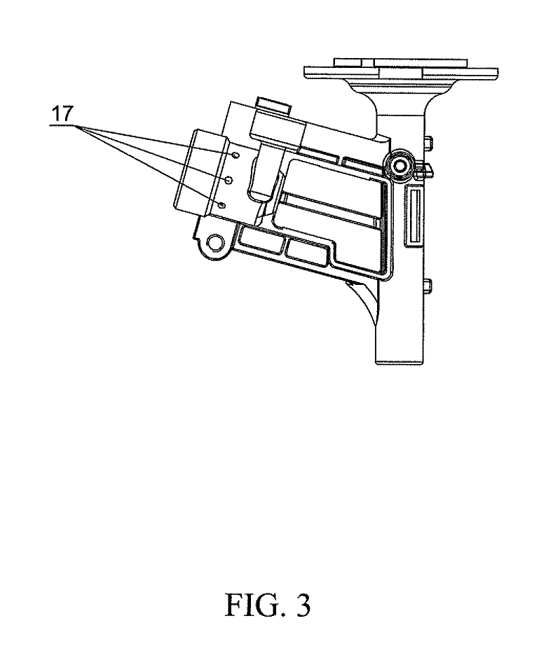

With reference to the drawings and in particular to FIGS. 1, 2, and 3, a gas-combustion coiled strip nail driving device comprises a housing 1 and a nose assembly. The housing 1 mounts therein a cylinder head 2, a movable sleeve 3, a cylinder block 4, and a piston assembly 5 that is arranged inside the cylinder block 4. The cylinder head 2, the movable sleeve 3, and the cylinder block 4 collectively define a combustion chamber 6. The nose assembly comprises a feeding mechanism that comprises a secondary cylinder 7. An exhaust passage 8 is formed in the cylinder head 2 and communicates the combustion chamber 6. The housing 1 has an outside surface on which a guide tube 9 is mounted in such a way that the guide tube 9 vertically extends along the housing 1. The guide tube 9 has a terminal end in communication with the exhaust passage 8. The terminal end is provided with a curve bent in a direction toward the housing 1. The guide tube 9 has an opposite end that is in communication with the secondary cylinder 7. The terminal end discussed above is of an S shape.

The exhaust passage 8 is arranged in a vertical direction in the cylinder head 2. The exhaust passage 8 has an exit where a discharge nozzle 10 in communication with the exhaust passage 8 is formed. The guide tube 9 is set in communication with the exhaust passage 8 through the discharge nozzle 10. The curve mentioned above is formed of a curved tube 11, and the guide tube 9 communicates the discharge nozzle 10 through the curved tube 11.

The secondary cylinder 7 has a wall in which exhaust holes 17 in communication with the secondary cylinder 7 are formed. The exhaust holes 17 are arranged in a bottom of the wall of the secondary cylinder 7. The exhaust holes 17 functions to discharge exhaust gas from the secondary cylinder 7 in order to ensure no reduction of force for the next nail driving operation will occur.

The operation of the present invention is as follows. A combustible gas is mixed with air and ignited for combustion inside the combustion chamber 6. The combustion generates high pressure gas that quickly drives the piston assembly 5 down to the bottom to drive a nail located in the nose into a workpiece. A negative pressure induced when the combusted gas is discharged out of the combustion chamber 6 and the cylinder block 4 helps fast returning the piston assembly 5 back to the original position. Meanwhile, the high pressure gas generated by the combustion is guided through the exhaust passage 8 of the cylinder head 2, the discharge nozzle 10, the curved tube 11, and the guide tube 9 to get into the secondary cylinder 7 to drive a striker to break nail wire and force the secondary piston 13 to move to the top end of the secondary cylinder. The exhaust holes 17 distributed around the secondary cylinder 7 discharges the exhaust gas from the guide tube 9 and the secondary cylinder 7 to ensure the air that is drawn into the combustion chamber 6 in the next nail driving operation is fresh and thus ensure the force for the next nail driving operation will not get weakening. Also, the feeding claw 14 overcomes the resistance provided by a feeding spring 15 to move in a direction away from the nose to get ready for next nail feeding operation. After the pressure of the high pressure gas inside the combustion chamber 6 is reduced, the secondary piston 13 and the feeding claw 14, under the action of the feeding spring 15, feed the nail for the next operation into the nose and the nail is held in position by an arresting claw 16 to be ready for the next nail driving operation.

Threaded collars 12 are provided at the connections between the discharge nozzle 10 and the exhaust passage 8, between the discharge nozzle 10 and the curved tube 11, and between the guide tube 9 and the secondary cylinder 7 to avoid leakage of the high pressure gas in the course of flow thereof that might lead to pressure reduction of the high pressure gas and eventually making the nail feeding device incapable of feeding nails or incapable of feeding nails to desired locations because of insufficiency of pressure of the high pressure gas. Further, the threaded collars 12 also provide functions of compression and coupling.

The guide tube 9 employed in the present invention can be a rubber hose, or alternatively, other materials can be used to make the guide tube 9.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A gas-combustion coiled strip nail driving device, comprising a housing and a nose assembly, the housing mounting therein a cylinder head, a movable sleeve, a cylinder block, and a piston assembly that is arranged inside the cylinder block, the cylinder head, the movable sleeve, and the cylinder block collectively defining a combustion chamber, the nose assembly comprising a feeding mechanism that comprises a secondary cylinder, characterized in that:
an exhaust passage is formed in the cylinder head and communicates the combustion chamber, the housing having an outside surface on which a guide tube is mounted in such a way that the guide tube vertically extends along the housing, the guide tube having a terminal end in communication with the exhaust passage, the terminal end being provided with a curve that is bent in a direction toward the housing, the guide tube having an opposite end that is in communication with the secondary cylinder, the terminal end being of an S shape.

2. The gas-combustion coiled strip nail driving device as claimed in claim 1, wherein the exhaust passage is arranged in a vertical direction in the cylinder head, the exhaust passage having an exit where a discharge nozzle in communication with the exhaust passage is formed, the guide tube being set in communication with the exhaust passage through the discharge nozzle.

3. The gas-combustion coiled strip nail driving device as claimed in claim 2, wherein the curve is formed of a curved tube and the guide tube communicates the discharge nozzle through the curved tube.

4. The gas-combustion coiled strip nail driving device as claimed in claim 3, wherein threaded collars are respectively provided at a connection between the discharge nozzle and the exhaust passage, a connection between the discharge nozzle and the curved tube, and a connection between the guide tube and the secondary cylinder.

5. The gas-combustion coiled strip nail driving device as claimed in claim 1, wherein, the guide tube comprise a metal tube or a rubber tube.

6. The gas-combustion coiled strip nail driving device as claimed in claim 5, wherein the secondary cylinder has a wall in which exhaust holes in communication with the secondary cylinder are formed, the exhaust holes being located at a bottom of the wall of the secondary cylinder.

7. The gas-combustion coiled strip nail driving device as claimed in claim 2, wherein, the guide tube comprise a metal tube or a rubber tube.

8. The gas-combustion coiled strip nail driving device as claimed in claim 7, wherein the secondary cylinder has a wall in which exhaust holes in communication with the secondary cylinder are formed, the exhaust holes being located at a bottom of the wall of the secondary cylinder.

9. The gas-combustion coiled strip nail driving device as claimed in claim 3, wherein, the guide tube comprise a metal tube or a rubber tube.

10. The gas-combustion coiled strip nail driving device as claimed in claim 9, wherein the secondary cylinder has a wall in which exhaust holes in communication with the secondary cylinder are formed, the exhaust holes being located at a bottom of the wall of the secondary cylinder.

11. The gas-combustion coiled strip nail driving device as claimed in claim 4, wherein, the guide tube comprise a metal tube or a rubber tube.

12. The gas-combustion coiled strip nail driving device as claimed in claim 11, wherein the secondary cylinder has a wall in which exhaust holes in communication with the secondary cylinder are formed, the exhaust holes being located at a bottom of the wall of the secondary cylinder.
